(19) United States
(12) Patent Application Publication
(10) Pub. No.: US 2009/0214771 A1
(43) Pub. Date: Aug. 27, 2009

(54) Manufacturing Method of Antimicrobial Fiber Using Nano Silver Powder

(76) Inventors: Hyunkyung Shin, Seoul (KR); Seogjoo Kang, Gyeonggi-do (KR)

Correspondence Address: John W Renner;RENNER OTTO BOISSELLE & SKLAR, 19th Floor, 1621 Euclid Avenue, Cleveland, OH, 44115, US

(21) Appl. No.: 11/992,022

(22) PCT Filed: Sep. 13, 2005
(86) PCT No.: PCT/KR2005/003032

§ 371 Date: Apr. 9, 2009

(30) Foreign Application Priority Data
Sep. 13, 2005 (KR) 10-2005-0085028

(51) Int. Cl. B05D 1/12

(52) U.S. Cl. 427/180

(57) ABSTRACT

Disclosed is a method for manufacturing a method for manufacturing antimicrobial fiber using nano silver powder, which can greatly increase the antimicrobial and bactericidal activities of fiber by preparing nano silver particles with high dispersibility and high purity in a continuous and easy manner and allowing fiber yarn to contain the prepared nano silver particles in an optimal manner. The method the steps of: dissolving a silver precursor in solvent; spraying the precursor solution in the form of fine droplets by any one technique selected from ultrasonic spraying, air-assist spray nozzle spraying and pressure nozzle spraying; transferring the sprayed droplet precursor into a thermal reactor or a flame reactor by carrier gas; decomposing the transferred precursor by heating at a temperature of 400-2,000° C. to prepare nano silver particles; collecting the prepared nano silver particles in a collector while cooling with cooling fluid of less than 200° C.; preparing master batch chips using the prepared nano silver particles; and mixing yarn raw material with the master batch chips to manufacture fiber yarn.

### BACKGROUND OF THE INVENTION

1. Field of the Invention

The present invention relates to a method for manufacturing antimicrobial fiber using nano silver powder, and more particularly, to a method for manufacturing antimicrobial fiber using nano silver powder, which can greatly improve the antimicrobial and bactericidal activities of fiber by preparing nano silver particles with high dispersibility and high purity by vapor phase synthesis in a continuous and easy manner and allowing fiber yarn to contain the prepared nano silver particles in an optimal manner.

2. Description of the Prior Art

Currently, synthetic fibers are used in many fields in a huge amount of a few million tons every year, and thus, in the clothing field, a need for antimicrobial activity has been proposed. To prepare such antimicrobial fibers, various organic and inorganic antimicrobial agents have been used. However, the organic antimicrobial agent has a problem in that it cannot be used in fibers, such as polyester or nylon, because, upon incorporation into a fiber spinning process, it decomposes in an extruder due to low thermal resistance. As an alternative to this organic antimicrobial agent, a silver-based ceramic antimicrobial agent having a silver compound attached to porous ceramic powder is used in the preparation of some of fibers. However, this silver-based ceramic antimicrobial agent has problems in that it causes yarn breakage during fiber spinning and cannot be used in the preparation of micro-fibers, because the ceramic powders have a very large size of micron order.

Also, since the amount of the silver-based compound contained in the silver-based ceramic antimicrobial agent is very low, the silver-based compound must necessarily be added to fibers in a large amount of a few percentages in order to manufacture antimicrobial fiber, and causes an increase in the production cost of antimicrobial fiber.

In recent attempts to solve the above-described problems, there was an attempt to manufacture antimicrobial fiber with durability by preparing ultra-fine nano silver powder with a size of less than 100 nanometers using nano-technology, and then, either post-treating fiber with the nano silver powder or incorporating the nano silver powder directly into fiber yarn in the spinning of synthetic fiber.

Korean patent registration No. 10-0484473 discloses a method for producing chemical fiber yarn using nano silver particles. The fiber yarn disclosed in this patent is characterized by containing 97-99.9% synthetic resin and 0.1-3% nano silver particles. However, the disclosed yarn is expensive and can cause the problem of spinnability, because they contain silver in a large amount of more than 0.1% (1,000 ppm).

As a method for preparing nano silver powder with excellent antimicrobial activity, a wet synthesis method is typically well known. However, in manufacturing antimicrobial fiber using a colloidal nano-silver solution obtained by the wet synthesis method, it is necessarily required to dry undesired liquid materials remaining after coating the nano-silver solution on a fiber raw material by, for example, spray coating.

Colloidal silver, a commonly used antimicrobial agent, is known to have an excellent inhibitory effect against bacteria, fungi and virus while showing no side effects. Particularly in the case of a colloidal silver solution having silver dispersed in the state of nanoparticles, the nano silver particles suffocate and kill virus, bacteria, mold and fungi by penetrating into the germ cells and stopping the function of enzymes required for the respiration of these germs. This is because not only silver performs bactericidal function by blocking the metabolism of the germs, but also an electrical charge emitted from metal silver inhibits the reproductive function of the germs.

Generally, colloidal silver is prepared as dispersion in water by a wet synthesis method, such as electrolysis or liquid phase reduction. The silver solution existing in an ionic state, obtained by the electrolysis, has a limitation in industrial applications due to low silver concentration. Also, the method for preparing a colloidal nano-silver solution in the form of an aqueous dispersion using a surfactant shows low silver concentration and has a limitation in obtaining high-purity nano silver particles due to the influence of the surfactant.

In addition, the nano silver particles themselves prepared by the prior wet synthesis method have a dark yellowish color. For this reason, when the nano silver particles are applied to fiber, it will be difficult to manufacture fiber with a color desired by users.

### SUMMARY OF THE INVENTION

Accordingly, the present invention has been made to solve the above-mentioned problems occurring in the prior art, and an object of the present invention is to provide a method for manufacturing antimicrobial fiber using nano silver powder, which can easily manufacture synthetic fiber with excellent antimicrobial and bactericidal activities by using nano silver particles prepared by vapor phase synthesis.

Another object of the present invention is to provide a method for manufacturing antimicrobial fiber using nano silver powder, which can optimize the particle size distribution of nano silver particles.

Still another object of the present invention is to provide antimicrobial fiber which shows excellent antimicrobial activity even when they contain a very small amount (less than 0.1%) of nano silver, unlike the prior antimicrobial fiber.

Yet another object of the present invention is to provide a method for manufacturing antimicrobial fiber, which can greatly increase fiber production efficiency by using nano silver particles with high purity and dispersibility.

To solve the above objects, the present invention provides a method for manufacturing antimicrobial fiber using nano silver powder, the method comprising the steps of: dissolving a silver precursor in solvent; spraying the precursor solution in the form of fine droplets by any one process selected from ultrasonic spraying, air-assisted spray nozzle spraying and pressure nozzle spraying; transferring the sprayed fine droplet precursor into a thermal reactor or a flame reactor by carrier gas; decomposing the transferred precursor by heating at a temperature of 400-2,000° C. to prepare nano silver particles; collecting the prepared nano silver particles in a collector while cooling with cooling fluid of less than 200° C.; preparing master batch chips using the prepared nano silver particles; and mixing a fiber yarn raw material with the master batch chips to manufacture fiber yarn.

In the step of dissolving the precursor in the solvent, the silver precursor is preferably any one selected from organic metal compounds of silver, including silver acetate, silver nitrate and a mixture thereof, and the solvent is preferably water or organic solvent.

In the transfer step, the carrier gas is preferably any one selected from oxygen, nitrogen and air.

The step of preparing the mater batch chips preferably comprises the sub-steps of: feeding the nano silver powder and polyester chips having an inherent viscosity of 0.6-0.8 into a mixer at a ratio of 1:100-2,000 and coating the nano silver powder on the surface of the polyester chips in the mixer; placing and melting the nano silver powder-coated polyester chips in a twin-screw extruder while stirring; and extruding the melted mixture in the form of a line with a given thickness while cooling, and cutting the extruded line into pellets.

The step of manufacturing the fiber yarn preferably comprises the sub-steps of: mixing polyester material with the master batch chips at a ratio of 10:1 to 20:1 in an agitator; melting the mixture in an extruder; and passing the melted mixture through a nozzle to prepare fiber yarns.

### BRIEF DESCRIPTION OF THE DRAWINGS

FIG. 1 is a field emission scanning electron microscope photograph of nano silver particles prepared by vapor phase synthesis according to the present invention.

FIG. 2 is an optical microscope photograph of master batch chips containing nano silver particles according to the present invention.

FIG. 3 is a photograph showing a polyester/nylon micro-fiber containing nano silver particles.

FIG. 4 is an optical microscope photograph showing that nano silver particles are distributed on the surface of a micro-fiber prepared according to the present invention.

FIG. 5 is a photograph showing the result of bacterial culture test for a control group.

FIG. 6 is a photograph showing the result of bacterial culture test for antimicrobial fiber according to the present invention.

### DETAILED DESCRIPTION OF THE PREFERRED EMBODIMENTS

Hereinafter, the method for manufacturing antimicrobial fiber using nano silver powder according to the present invention will be described in detail with reference to the accompanying drawings.

The present invention is mainly characterized in that fiber having excellent antimicrobial activity even at a low silver content of less than 0.1% (1,000 ppm) can be easily manufactured using uniform silver particles with high purity and high dispersibility, prepared by vapor phase synthesis in a completely different manner from the prior methods for preparing nano silver particles. Also, the present invention is characterized by providing antimicrobial fiber showing perfect antimicrobial activity even at a silver content of less than 0.01% (100 ppm) and characterized in that, owing to the excellent dispersibility of nano silver particles, the preparation of fiber yarns is performed with excellent spinnability.

The method for manufacturing antimicrobial fiber using nano silver powder according to the present invention broadly comprises the steps of: preparing nano silver powder by vapor phase synthesis; preparing master batch chips using the nano silver powder; and mixing the master batch chips with a fiber yarn raw material to manufacture antimicrobial fiber.

Each of the steps will now be described in detail.

### Step of Preparing Nano Silver Powder by Vapor Phase Synthesis

(a) A silver precursor is dissolved in a suitable solvent.

The silver precursor used in the present invention may be selected from organic metal compounds of silver, such as silver acetate, silver nitrate and a mixture thereof. For use in the present invention, the precursor is dissolved in water or organic solvent at suitable concentration.

(b) The prepared precursor solution is sprayed in the form of fine droplets.

Spraying the precursor solution in the form of fine droplets is performed by any one technique selected from ultrasonic spraying, air-assisted spray nozzle spraying, and pressure nozzle spraying. By this spray technique, the precursor solution is sprayed in the form of fine droplets with a size of less than a few tens of microns.

The ultrasonic spraying is performed by spraying the precursor solution in the form of fine droplets by, for example, an ultrasonic vibrator.

The air-assisted spray nozzle spraying is performed by discharging the precursor solution through a nozzle and injecting air around the discharged precursor under high pressure so as to draw out the precursor solution by the injected air.

The pressure nozzle spraying is performed by pushing out the precursor solution by the application of high pressure.

(c) The sprayed precursor droplets are transferred into a thermal reactor or a flame reactor by carrier gas.

Examples of the carrier gas which can be used in the present invention include oxygen, nitrogen and air.

(d) The transferred precursor is decomposed by heating at a temperature of 400-2,000° C. to prepare nano silver particles.

The silver precursor transferred into the reactor is instantaneously decomposed to obtain nano-sized silver particles. At this time, since the precursor is heated at high temperature, undesired impurities excluding silver become gas phase which is drawn out through a dust collection filter, and only high-purity nano silver particles are collected.

If, for example, silver nitrate is used as the silver precursor, nano silver particles will be obtained by the following reaction equation:

AgNO₃→Ag+NOₓ

If the heating temperature is lower than 400° C., the decomposition reaction of silver will not be sufficiently made, and a heating temperature higher than 2,000° C. will impose many limitations on a heating device and would not show additional effects.

(e) The prepared nano silver particles are gathered in a collector while cooling with cooling fluid of less than 200° C.

The prepared nano silver particles are rapidly cooled to a temperature of less than 200° C. with cooling fluid, such as water, nitrogen or air, thus preparing high-purity nano silver particles which show no cohesion and have small and uniform particle size and no impurities.

If the cooling temperature is higher than 200° C., the resulting nano silver particles will become too large, and the thermal durability of the collector will be reduced.

The nano silver particles prepared by the above-described method have not only very uniform particle size but also high purity, because the reaction is performed at a high temperature of more than 400° C. so that the nano silver particles contain no organic material, such as a surfactant, which will remain in the case of a wet synthesis method. Also, since the preparation of nano silver powder from the precursor at high temperature is made within a short time of less than a few seconds, a large amount of nano silver powder is continuously obtained.

Furthermore, the nano silver particles prepared by the present invention have an advantage in that they can be very easily dispersed in polymer material, because they have a very small and uniform particle size of less than a few tens of nanometers as well as low cohesion and excellent dispersibility. By these characteristics, the inventive nano silver particles show excellent antimicrobial activity even in a low amount of less than 0.1% relative to the amount of synthetic fiber raw material.

### Step of Preparing Master Batch Chips Using Prepared Nano Silver Powder

(f) The nano silver powder and polyester chips having an inherent viscosity of 0.6-0.8 are fed into a super mixer where the nano silver powder is coated on the surface of the polyester chips.

At this time, the feed ratio of the nano silver powder to the polyester chips is preferably 1:100-2,000.

(g) The polyester chips coated with the nano silver powder are placed and melted in a twin-screw extruder.

(h) The melted mixture is extruded in the form of a line with a given thickness while cooling, and then, the extruded line is cut into pallets.

### Step of Manufacturing Micro-Fiber Containing Nano Silver Particles

(i) Polyester material and the master batch chips are mixed with each other at a ratio of 10:1-20:1 in an agitator.

(j) The mixture is melted in an extruder.

(k) The melted mixture is passed through a nozzle to prepare fiber yarn.

As the raw material of the fiber yarns, melt-spinnable synthetic fiber raw material, such as nylon (e.g., nylon 6, nylon 66, etc.) or polypropylene, may be used in addition to polyester.

Hereinafter, the method for manufacturing antimicrobial fiber using nano silver powder according to the present invention will be described in detail by an example. It is to be understood, however, that this example is given for illustrative purpose only and is not construed to limit the scope of the present invention.

### EXAMPLE

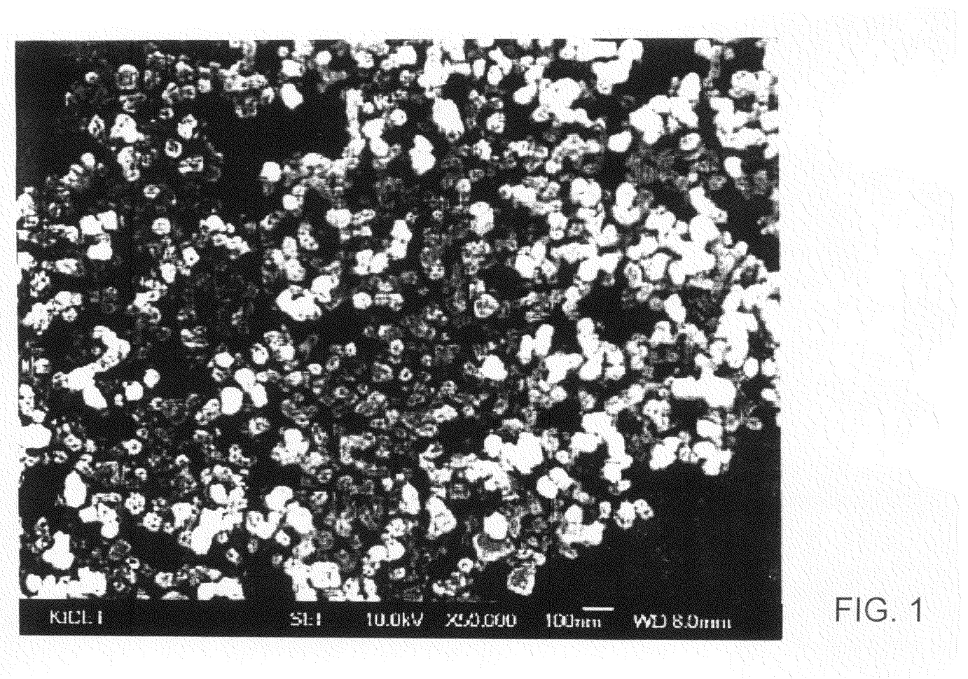

100 g of silver nitrate was dissolved in 1,000 cc of water, and the silver solution was sprayed through an ultrasonic spray nozzle in an amount of 500 cc per hour. The sprayed droplets were transferred into a tube reactor by carrier gas. As the carrier gas, nitrogen gas was used. The droplets transferred into the reactor were allowed to react at a temperature of 900° C., thus obtaining nano silver powder with a size of 30 nm. The obtained nano silver powder was analyzed by a field emission scanning electron microscope (FE-SEM), and the result is shown in FIG. 1. As shown in FIG. 1, the nano silver powder had a very uniform particle size.

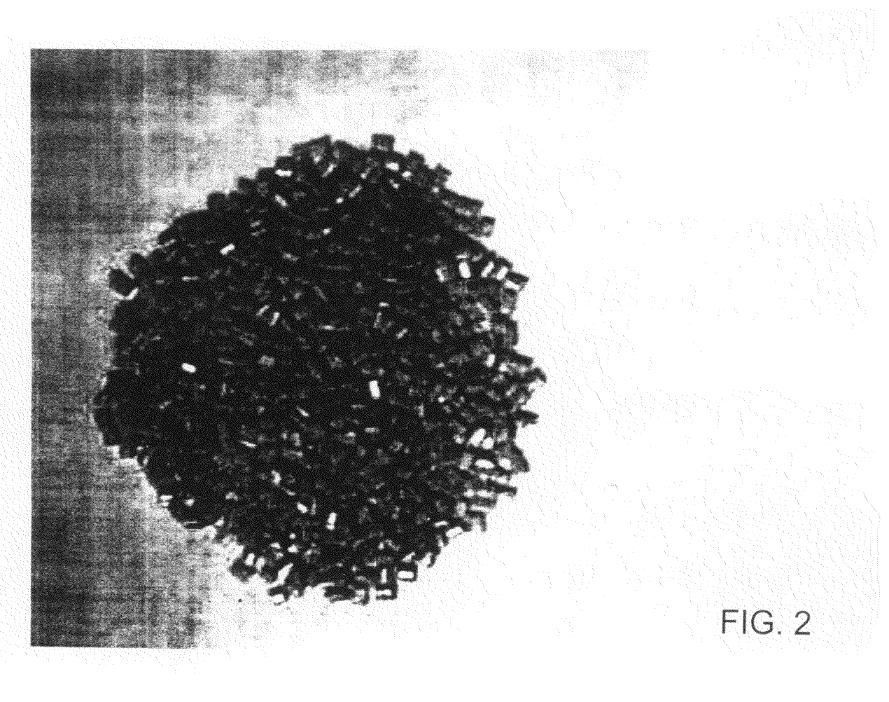

1 kg of the nano silver powder obtained as described above and 500 kg of polyester chips with an inherent viscosity of 0.6 were fed and mixed with each other in a super mixer, and the mixture was melted and passed through a twin-crew extruder to prepare pellets. In this way, the master batch chips having a silver concentration of 2000 ppm and a good color as shown in FIG. 2 could be obtained.

In the manufacturing of micro-fiber made of polyester/nylon (7/3), the master batch chips and polyester material were mixed with each other at a ratio of 10:90, and fiber yarn of 75 deniers/36 filaments was manufactured using the mixture by a conventional method. The manufactured fiber contained 0.02% (200 ppm) of the nano silver particles.

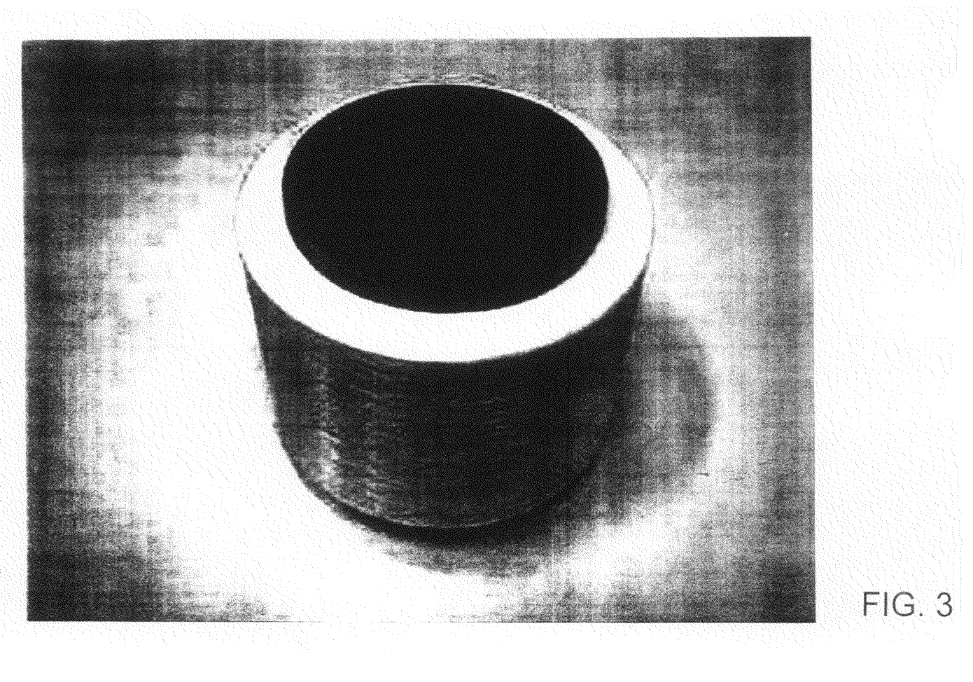

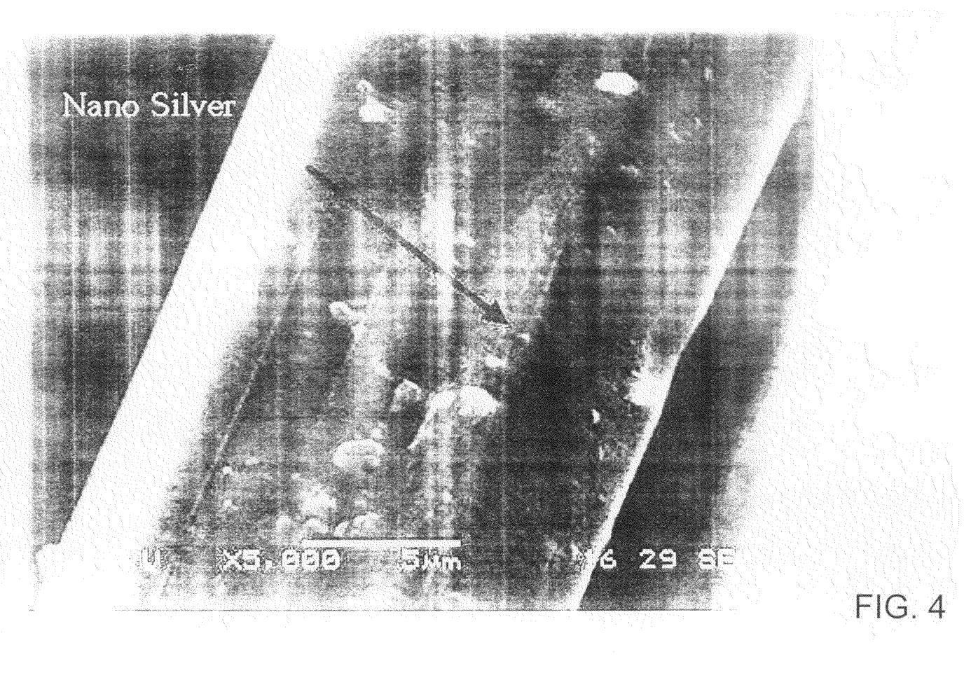

FIG. 3 shows a photograph of the fiber yarn prepared by the present invention, and FIG. 4 is a photograph of the micro-fiber surface, taken with a scanning electron microscope. As can be seen in FIG. 4, the nano silver particles were well distributed on the surface of the micro-fiber.

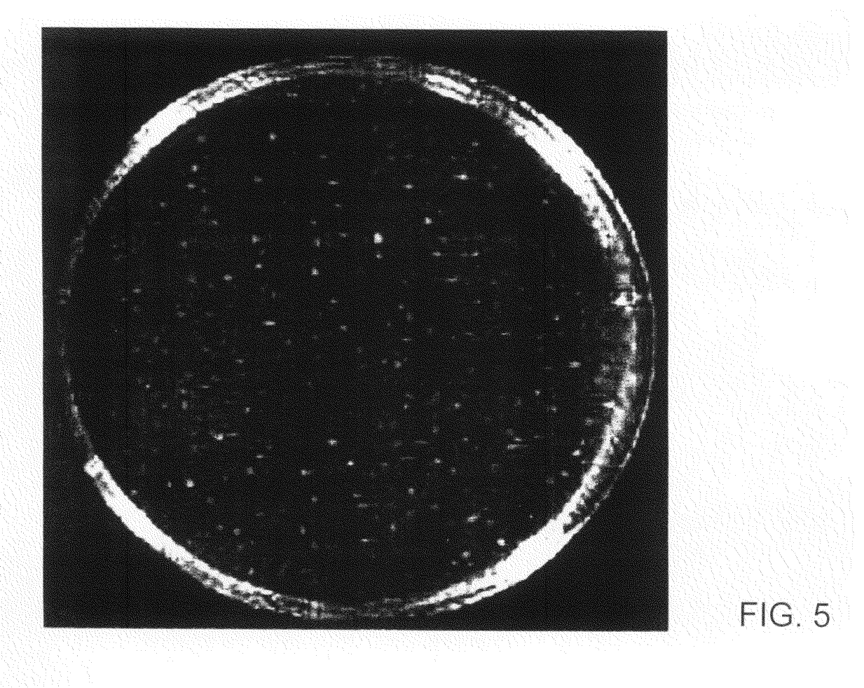

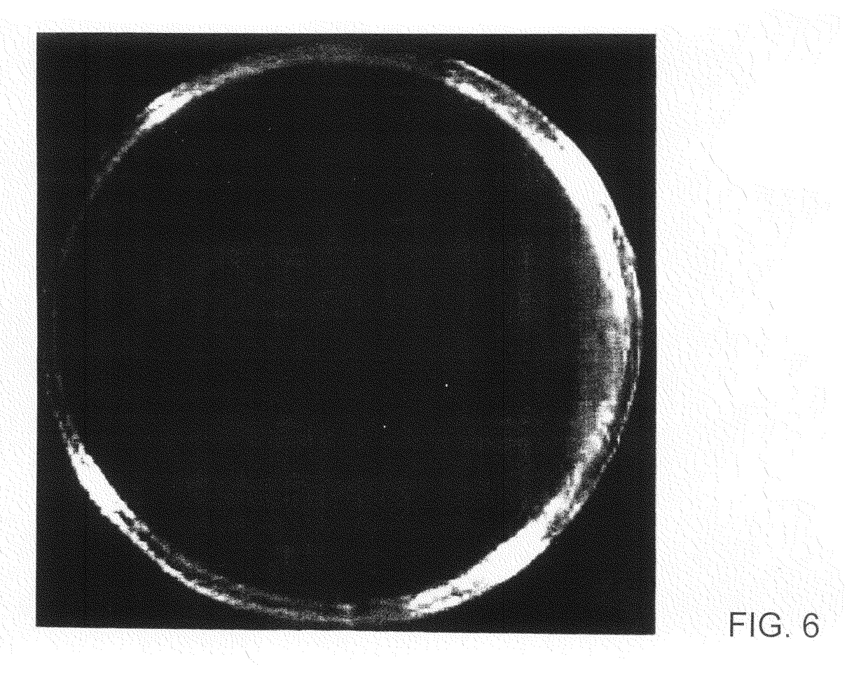

In addition, the inventive antimicrobial fiber manufactured in the above example was evaluated for antimicrobial activity. The results are shown in FIG. 5 for a control group and FIG. 6 for the inventive example.

Tables 1 and 2 show the results of antimicrobial tests for the invention and the control group. FIG. 5 is the test result for the control group sample and shows that germs propagated after 24 hours, and FIG. 6 is the test result for the inventive antimicrobial fiber and shows that germs were all killed.

TABLE 1
Antimicrobial test (strain: Staphyllococcus
aureus ATCC 6538)

| | Before test | After 18 hours | Eradication rate |
|---|---|---|---|
| Control group | 1.3 × 10⁵ | 6.2 × 10⁶ | — |
| Example | 1.3 × 10⁵ | <10 | 99.9 |

TABLE 2
Antimicrobial test (strain: Klebsiella
pneumoniae ATCC 4352)

| | Before test | After 18 hours | Eradication rate |
|---|---|---|---|
| Control group | 1.3 × 10⁵ | 6.2 × 10⁶ | — |
| Example | 1.3 × 10⁵ | <10 | 99.9 |

As can be seen in Tables 1 and 2, the antimicrobial fiber manufactured according to the present invention had almost perfect antimicrobial activity, whereas the control group showed about 5 times increase in the number of the germs.

As described above, the present invention provides the method for continuously synthesizing a large amount of nano silver powder by vapor phase synthesis, but not by liquid phase synthesis. Also, the nano silver powder prepared by vapor phase synthesis has an ultra-high purity of more than 99%, and is uniform in particle size, and thus, shows excellent extrudability upon application to synthetic fiber.

Moreover, synthetic fiber manufactured using the nano silver powder obtained in the present invention will have preferred properties upon use in clothing applications, because they do not show a dark yellowish color, unlike fibers manufactured by the prior wet synthesis method.

In addition, by the present invention, antimicrobial fiber with excellent resistance to laundering as compared to fibers manufactured by the existing post-treatment method can be manufactured.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method for manufacturing antimicrobial fiber using nano silver powder, the method comprising the steps of:
dissolving a silver precursor in solvent;
spraying the precursor solution in the form of fine droplets by any one technique selected from ultrasonic spraying, air-assisted spray nozzle spraying and pressure nozzle spraying;
transferring the sprayed droplet precursor into a thermal reactor or a flame reactor by carrier gas;
decomposing the transferred precursor by heating at a temperature of 400-2,000° C. to prepare nano silver particles;
collecting the prepared nano silver particles in a collector while cooling with cooling fluid of less than 200° C.;
preparing master batch chips using the prepared nano silver particles; and
mixing yarn raw material with the master batch chips to manufacture fiber yarn.

2. The method of claim 1, wherein the silver precursor used in the step of dissolving the precursor in the solvent is any one selected from organic metal compounds of silver, including silver acetate, silver nitrate and a mixture thereof, and the solvent is water or organic solvent.

3. The method of claim 1, wherein the transfer step used in the transfer step is any one selected from oxygen, nitrogen and air.

4. The method of claim 1, wherein the step of preparing the mater batch chips comprises the sub-steps of:
feeding the nano silver powder and polyester chips having an inherent viscosity of 0.6-0.8 into a mixer at a ratio of 1:100-2,000 and coating the nano silver powder on the surface of the polyester chips in the mixer;
placing and melting the nano silver powder-coated polyester chips in a twin screw extruder while stirring; and
extruding the melted mixture in the form of a line with a given thickness while cooling, and cutting the extruded line into pellets.

5. The method of claim 4, wherein the step of manufacturing the fiber yarn comprises the sub-steps of:
mixing polyester material with the master batch chips at a ratio of 10:1 to 20:1 in an agitator;
melting the mixture in an extruder; and
passing the melted mixture through a nozzle to prepare fiber yarns.
